(19) United States
(12) Patent Application Publication
(10) Pub. No.: US 2020/0228612 A1
(43) Pub. Date: Jul. 16, 2020

(54) DIGITAL ASSISTANT SYSTEM PROVIDING ADVANCED CUSTOMIZABLE SERVICES FOR A USER

(71) Applicant: Joshua Salters, Rochester, NY (US)

(72) Inventor: Joshua Salters, Rochester, NY (US)

(21) Appl. No.: 16/248,834

(22) Filed: Jan. 16, 2019

(51) Int. Cl. H04L 29/08; G06N 20/00

(52) U.S. Cl. CPC H04L 67/16; H04L 67/22; H04L 67/42; H04L 67/306; G06N 20/00

(57) ABSTRACT

A digital assistant system providing advanced customizable services for a user, the system includes at one client device, a first database for storing user profile information, an optimization engine, and a server. The at least one client device includes one or more computer programs, one or more computer-readable storage media, one or more processor, and a digital assistant. The digital assistant is configured to receive one or more user selected customizable services, monitor activity on the client device and autonomously perform advanced services to assist the user based on the monitored activity, the advanced services provided include enhanced essential services and the user's selected one or more customizable services. The optimization engine includes one or more computer programs, one or more computer-readable storage media, and at least one machine-learning processor. The optimization engine is configured to perform, at the direction of the server, one or more advanced customizable services for the user based on training analysis of training data performed by the machine-learning processor. The at least one server having one or more computer programs, one or more processors and one or more computer-readable storage media. The at least one server is configured to receive activity information from the at least one client device, coordinate with the at least one client device and the optimization engine to initiate one or more advanced customizable services for the user when activity information received from the client is related to a first category of services, and perform one or more advanced customizable services for the user when activity information received from the at least one client is related to a second category of services.

### FIELD OF THE INVENTION

Embodiments described herein generally relate to digital assistants, and more particularly to a digital assistant system providing customizable services.

### BACKGROUND OF THE INVENTION

Cellular phones and other similar devices are a necessary part of everyday life. Nonetheless there is a need for them to assist their owners in completing various tasks. Currently, on the market, there are various cell phone devices. However, these devices lack advanced artificial intelligence that perform optimized services. Hence, it is desirable to provide a digital assistant with advanced services.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary architecture diagram of a digital assistant system providing advanced customizable services for a user according to an embodiment of the present disclosure.

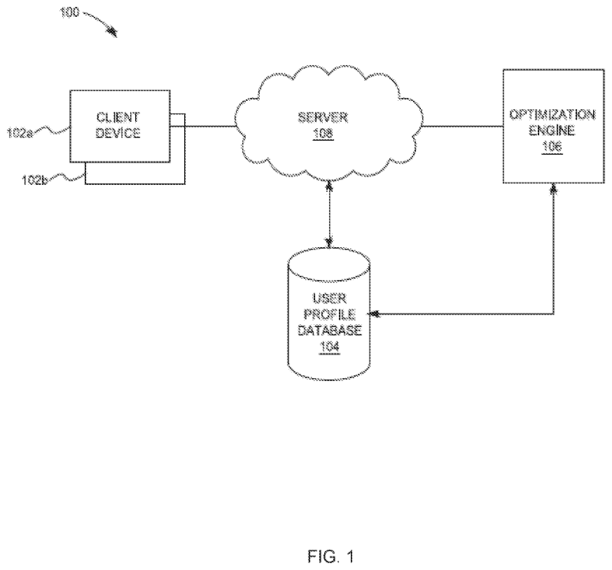

### SUMMARY OF THE INVENTION

Exemplary embodiments disclosed herein describe a digital assistant system providing advanced customizable services for a user. The system includes at one client device, a first database for storing user profile information, an optimization engine, and a server. The at least one client device including one or more programs, one or more computer-readable storage media, one or more processors and a digital assistant. The digital assistant is configured to receive the user's selection of one or more customizable services to be provided to the user; monitor activity on the client device, and autonomously perform advanced services to assist the user based on the monitored activity, the advanced services provided include enhanced essential services and the user's selected one or more customizable services. The optimization engine includes one or more computer programs, one or more computer-readable storage media and at least one machine-learning processor. The optimization engine is configured to perform, at the direction of the server, one or more advanced customizable services for the user based on optimized training analysis of the training data performed by the machine-learning processor. The at least one server having one or more computer programs, one or more processors and one or more computer-readable storage media. The at least one server is configured to receive activity information from the at least one client device, coordinate with the at least one client device and the optimization engine to initiate one or more advanced customizable services for the user when activity information received from the client is related to a first category of services, and perform one or more advanced customizable services for the user when activity information received from the at least one client is related to a second category of services.

### DETAILED DESCRIPTION

The present disclosure relates to a digital assistant system providing advanced services to a user (“the system”). As illustrated in claim 1, the system 100 includes one or more client devices 102a and 102b, a first database 104, an optimization engine 106, and at least one server 108. The one or more client devices 102, optimization engine 106 and the at least one server 108 collectively work together to provide advanced services to the user. The client device performs advanced services that do not consume a lot of resources. The optimization engine performs services that use machine learning processing. The server performs advanced services that consume a lot of resources.

The one or more client devices includes one or more computer-readable storage media, one or more processors and one or more computer programs. The one or more client devices 102a and 102b may be implemented as a smart phone, a mobile phone, a hand-held device, a personal computer, minicomputer, microprocessor, workstation, mainframe, or similar computing platform. In a preferred embodiment, the client device is a smart phone.

One or more of the computer programs may include code that can be used to run a digital assistant program. The digital assistant may be voice activated and include a customizable avatar for interfacing with the user. Although the digital assistant is described as voice activated, the digital assistant may be activated by any suitable means. The digital assistant receives one or more user selectable customizable features. A user is able to select a number of services that the user desires the digital assistant to provide. At first use, a user will activate the digital assistant through voice activation. The digital assistant will prompt the user to setup a profile. The profile information may include user preferences and one or more customizable services selected by the user. The profile information is stored in user profile database 104.

The system 100 offers essential features and user selected customizable services. The essential features are non-electable and include optimized search services and email processing services. These essential features may be customized by the user. The user selectable customizable features include virus cleanup, network data expansion, tax preparation, client-to-client connection, content censorship, parental controls, relationship help and human emotion detection.

The system 100 provides two categories of services for processing. The first category of services are services that are processed using machine learning models. The first group of services include content censorship, parental controls, relationship help, human emotion detection, and optimized search capabilities. The first category of services are performed by the optimization engine. The second category of services are services that are performed using enhanced features without machine learning models. The second group of services include virus cleaning, network data expansion, tax preparation, client-to-client connection and email processing.

The content censorship service identifies inappropriate body parts, imagery and language in communications, photos or videos and blurs out the identified inappropriate body and imagery and beeps out inappropriate language. The system has recognition programing that identifies inappropriate body parts, imagery, and language. The systems will automatically provide a filter that blurs and beeps out those inappropriate body parts, images, and/or language uses.

The parental control service monitors and limits a child's time on games, calls, texting and web surfing. When the user sets up a profile as being a parent and/or guardian, the digital assistant will ask several questions that will revolve around the security of the system. For example, it will ask what kind of time limit you would like to put on your child's time for things like games, texting, calls, surfing the web, etc. For a further example on that particular setting feature, you can set it up to where after 9 pm they have precisely 30 minutes until the games, texting, calls, web surfing, etc. are closed and automatically shut off until 8 am when they will be activated and useable again.

The relationship help service monitors, detects and prevents inappropriate communications sent by a user in a relationship to an individual that the user is not in a relationship with. The digital assistant, during profile setup, will ask the user personal questions such as their marital status. It will provide the user with answerable options such as you are married or you are seeing someone. If you are seeing someone, it will ask if this person also has an account. If they do, the user would type their number or account details in and it will send that person a link that will ask them to connect their account together with yours. They will be able to select yes, no, or personal open options. If they select no, then it will decline the capabilities between accounts. If they select yes, it will open capabilities between accounts. The final option, being a personalized option, is where the partner will be able to choose what they do and do not desire to share and make capable between accounts. An example of this would be to receive a text which will announce a warning if the partner has sent out any inappropriate body parts or imagery that could be considered an undesired sight. They will then have the option to view the image or decline. The system does have a word recognition program and, in its database, will have a list of these words similar to a phone's recognition to popular word usage used by each account.

The human emotion detector service determines human emotion based on sensory changes and emotional admissions. The sensory changes are determined using a heat panel that interfaces with the user. The client device will have a heat panel which will determine sensory changes and emotional emissions. The digital assistant will ask questions based on the user's body temperature to also determine a person's mood or emotion. In an alternative embodiment, if the digital assistant hears the user crying, the digital assistant will ask the user what is wrong and proceed to try to cheer the user up.

The optimized search capabilities determines what the desired scope of information is sought by the user and provides a streamlined search to obtain the desired scope of information. When searching things, the digital assistant will dive a little deeper. For example, when the user is looking up how to fix a car, the digital assistant will ask the user whether the user has any knowledge on fixing cars and will provide the following options 1. none at all; 2. I have some knowledge or 3. I know my cars. If the user has no knowledge, the digital assistant will look for first timer videos and/or books. If the user chooses options 2 or 3, the digital assistant will ask the user what he/she doesn't know specifically and the system will search for information accordingly.

The virus cleanup will be initiated when a USB connection is made to the client. The digital assistant will give the user options on why the USB is connected to the given device which includes: Options 1: Charging a phone or other device. Option 2: Clean virus off of phone or another device. When selecting option 2, the digital assistant will bring up an interface for scanning and search for corrupted files, bugs, viruses and cookies.

When completed searching, the digital assistant will announce how much of a threat the viruses are. There are several levels of threats depending on the device and its usage. If the threat level is low, the digital assistant will suggest cleaning it and/or clearing unnecessary files. The digital assistant can clean and clear files and viruses at a lower level, but if the threat level is high, the digital assistant will then suggest third party software.

The network data expansion is initiated when the user has exhausted all of its data. For example, when the user's network provider, such as Verizon, AT&T, T-Mobile, etc., provide an indication that the user has used all of its data, the system will provide the user with limited time to utilize such things so that the user can still have access to the internet, calling and texting features, and applications. When the user gets the message from a network service provider stating that the user has used all of its data, the digital assistant will pop up and openly sense that the data provided by network service provider is no longer available, and would ask the user, “Would you like to use the data on the system?” There must be Internet or a Wi-Fi connection within the area to further use this feature.

The tax preparation service will pop up and openly address to the user that it is tax season. At this point, the digital assistant will ask if the user whether the user would like to continue with doing his/her taxes immediately, or if the user would like to schedule this event for a later date and time. When the user is ready, the digital assistant will then have options and suggestions on how to get your taxes done. The options available are: Option 1: letting the digital assistant do the user's taxes for the user. The digital assistant will ask the user several related questions and will requests pictures of the user's most recent pay stubs. Option 2: if the user does not trust the digital assistant to do his/her taxes, the user informs the digital assistant system that he/she would like to do their taxes elsewhere. The digital assistant will simply suggest other services that will help the user get his/her taxes done.

The client-to-client connection service would be for parent/guardian and child regulations. This includes giving the parent/guardian updates on the child's schedule and their state of mind. State of mind would be meaning and understanding how they are feeling during the day and about certain topics that the child is associated with. For example, it could provide recent Google search history and alarm setting the child has set on their phone.

The email processing service processes emails request. When the user sets up its initial profile, the digital assistant will ask the user for information connecting to the user's desired email. The system does have the capability to handle multiple emails.

The digital assistant monitors activity on the client device. The activities monitored by the digital assistant may include USB connection detection, notification of network data exhausted, a tax preparation trigger, a web search query, incoming and outgoing communications, request to connect to another client device, user sensory changes, activity time monitoring, and email processing requests.

The digital assistant autonomously performs advanced services to assist the user based on the monitored activity. The digital assistant also uses voice queries and a natural-language user interface to answer questions, make recommendations, and perform actions by delegating requests to a set of Internet services.

The optimization engine 106 includes one or more computer-readable storage media, one or more computer programs, and at least one machine-learning processor. The optimization engine is configured to perform, at the direction of a server, one or more advanced services for the user based on training analysis of data performed by the machine-learning processor. The machine-learning processor performs the training analysis by processing one or more computer programs that receive input data and use statistical analysis to predict an output while updating outputs as new data becomes available. The training analysis may include searching through data to look for patterns and adjusting program actions accordingly. The optimization engine 106 performs the services belonging to the first category of services.

Server 108 includes one or more programs, one or more processors and one or more computer readable storage media. The server is configured to receive activity monitoring information from one or more of client devices 102a and 102b, coordinate with the at least one client device and the optimization engine to initiate one or more advanced services for the user when activity information received from the client is related to a first category of services, and to perform one or more advanced services for the user when activity information received from the at least one client is related to a second category of services.

The server 108 is able to determine what type of service should be initiated from the activity monitoring information and based on the user selected customizable services stored in the user profile database 104. When the activity monitoring information triggers one or more advanced services, the server will only initiate the service for user selectable customizable services that have been selected by the user.

When the activity monitoring information indicates a USB connection detection, the server directs the client 102 to perform the virus cleanup service. When the activity monitoring information indicates a notification of network data exhausted, the server performs the network data expansion service. When the activity monitoring information indicates a tax preparation trigger, the server directs the client to perform the tax preparation service. When the activity monitoring indicates a web search query, the server performs the optimized search service.

When the activity monitoring information indicates incoming and outgoing communications, the server directs the optimization engine to perform the content censorship and relationship help services. When the activity monitoring information indicates user sensory changes, the server directs the optimization engine to perform the human emotion detector service. When the activity monitoring information indicates activity time monitoring triggers, the server direct the optimization engine to perform the parental control services. When the activity monitoring information indicates a request to connect to another client device, the server directs the client device to perform the client-to-client service. When the activity monitoring information indicates an email processing request, the server directs the client to perform the email processing service.

The one or more computer programs are stored in the one or more computer-readable storage media. The one or more computer programs may comprise multiple hardware or software modules and contain program instructions that cause the one or more processors to perform various tasks, functions or features.

The computer programs contain program instructions that are converted to executable code. The executable code is committed to memory using machine codes selected from the specific machine language instruction set, or native instructions, designed into the hardware microprocessor. The hardware microprocessor is configured to perform a predefined set of logic operations in response to receiving a corresponding basic instruction selected from a predefined native instruction set of machine codes. Each native instruction is a discrete code that is recognized by the hardware microprocessor and that can specify particular registers for arithmetic, addressing, or control functions; particular memory locations or offsets; and particular addressing modes used to interpret operands. The program instructions are a set of machine codes that are selected from the native instruction set that are processed by the hardware microprocessor.

The present disclosure may be described in the general context of computer code or machine-useable instructions, including computer-executable instructions such as program modules, being executed by a computer or other machine, such as a personal data assistant or other handheld device. Generally, program modules include routines, programs, objects, components, data structures, etc., and refer to code that perform particular tasks or implement particular abstract data types. The present disclosed system 100 may be practiced in a variety of system configurations, including hand-held devices, consumer electronics, general-purpose computers, more specialty computing devices, etc. The present disclosed system may also be practiced in distributed computing environments where tasks are performed by remote-processing devices that are linked through a communications network.

Computer-readable storage media include volatile and nonvolatile, removable and non-removable media implemented in any method or technology for storage of information such as computer-readable instructions, data structures, program modules or other data. Computer-readable storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the any of the one or more processors. Computer storage media excludes signals per se.

Memory generally includes computer-readable storage media in the form of volatile and/or nonvolatile memory. The memory may be removable, non-removable, or a combination thereof. Exemplary hardware devices include solid-state memory, hard drives, optical-disc drives, etc. Processor is a hardware computing device and generally includes central processing unit, microprocessor, graphics processing unit, digital signal processor, application-specific instruction set processor (ASIP), machine-learning processor—a specialized microprocessor designed specifically for processing machine learning models—, physics processing unit (PPU), image processor, coprocessor, floating-point unit, network processor,

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A digital assistant system providing advanced services for a user, the system comprising:
at least one client device including one or more computer programs, one or more computer-readable storage media, one or more processors and a digital assistant, the digital assistant is configured to:
receive the user's selection of one or more customizable services to be provided to the user;
monitor activity on the client device;
autonomously perform advanced services to assist the user based on the monitored activity, the advanced services provided include enhanced essential services and the user's selected one or more customizable services;
a first database storing user profile information;
an optimization engine comprising one or more computer programs, one or more computer-readable storage media and at least one machine-learning processor, the optimization engine is configured to:
perform, at the direction of the server, one or more advanced services for the user based on training analysis of data performed by the machine-learning processor; and
at least one server, the server having one or more computer programs, one or more processors and one or more computer-readable storage media, the server configured to:
receive activity information from the at least one client device;
coordinate with the at least one client device and the optimization engine to initiate one or more advanced services for the user when activity information received from the client is related to a first category of services; and
perform one or more advanced services for the user when activity information received from the at least one client is related to a second category of services.

2. The system of claim 1, wherein the first category of services are services that are optimized using machine learning models, and the second category of services are services that are performed using enhanced features without using machine learning models.

3. The system of claim 1, wherein the first category of services include at least one or more services from the group comprising content censorship, parental controls, relationship help, human emotion detection, and optimized search capabilities.

4. The system of claim 1, wherein the second category of services include at least one or more services from the group comprising virus cleaning, network data expansion, tax preparation, client-to-client connection and email processing.

5. The system of claim 3, wherein the content censorship service identifies inappropriate body parts, imagery and language in communications, photos or videos and blurs out the identified inappropriate body and imagery and beeps out inappropriate language.

6. The system of claim 3, wherein the parental control service monitors and limits a child's time on games, calls, texting and web surfing.

7. The system of claim 3, wherein the relationship help service monitors, detects and prevents inappropriate communications sent by a user in a relationship to an individual that the user is not in a relationship with.

8. The system of claim 3, wherein the human emotion detector service determines human emotion based on sensory changes and emotional admissions.

9. The system of claim 8, wherein the sensory changes are determined using a heat panel that interfaces with the user.

10. The system of claim 3, wherein the optimized search capabilities determines what the desired scope of information is sought by the user and provides a streamlined search to obtain the desired scope of information.

11. The system of claim 1, wherein the enhanced essential features include optimized searching capability and email processing.

12. The system of claim 1, wherein the user selectable customizable services include virus cleaning, network data expansion, tax preparation, client-to-client connection, content censorship, parental controls, relationship help and human emotion detection.

13. The system of claim 1, wherein the digital assistant includes an avatar for interfacing with the user.

14. The system of claim 1, wherein the digital assistant is voice activated.
